(19) United States
(12) Patent Application Publication
(10) Pub. No.: US 2026/0131219 A1
(43) Pub. Date: May 14, 2026

(54) SYSTEMS AND METHODS OF AUTOMATED DISPLAY SYNCHRONIZATION

(71) Applicant: SDI Technologies, Inc., Rahway, NJ (US)

(72) Inventors: Marc Chrem, Rahway, NJ (US); Nissim Bussu, Rahway, NJ (US)

(73) Assignee: SDI Technologies, Inc., Rahway, NJ (US)

(21) Appl. No.: 19/388,878

(22) Filed: Nov. 13, 2025

Related U.S. Application Data
(60) Provisional application No. 63/720,454, filed on Nov. 14, 2024.

(51) Int. Cl. A63B 71/06; G06F 3/14

(52) U.S. Cl. CPC A63B 71/0669; G06F 3/1423

(57) ABSTRACT

At least one aspect of the technical solution is directed to a system that can include one or more processors coupled with memory. The one or more processors can receive an indication representative of interactions of a plurality of objects with one or more portions of a first gameboard or a second gameboard. The one or more portions can include i) a first portion and a second portion. The one or more processors can transmit, to the second board, a wireless communication signal, in response to receiving the indication of interactions with the one or more portions of the first gameboard. The one or more processors can display, on the first gameboard and the second gameboard, a score indicating the interactions of the first object and the interactions of the second object on the one or more portions of the first gameboard.

### CROSS REFERENCE TO RELATED APPLICATIONS

The present application claims priority to U.S. Provisional Patent Application No. 63/720,454, field Nov. 14, 2024, which is incorporated herein by reference in its entirety.

### BACKGROUND

This disclosure generally relates to systems and methods of automated scoreboard synchronization, including for outdoor games such as cornhole

### SUMMARY

The technical solutions of the present disclosure are directed to systems and methods for automated scoreboard synchronization across gameboards, including for outdoor games such as cornhole. When tracking the scores of each team outside on the scoreboard, errors can occur if each round is not tracked properly. Additionally, players or equipment can inadvertently move the board or bags during play, complicating point calculation and tracking further. Systems and methods in accordance with the present disclosure can integrate components for receiving and maintaining score information into gameboards, can synchronize score information between multiple gameboards, and can perform the synchronization in a manner that avoids excessive power usage from batteries in the board, allowing for longer term, more reliable operation.

The systems and methods described herein can allow for the components of the gameboard to improve data consistency between remote displays. The lack of data consistency can cause drift between two interconnected wireless devices. Therefore, during one or more clock cycles, one gameboard can update without the other gameboard updating to include to correct score. In this manner, the systems and methods described herein can reduce the occurrence of data drift and can improve the data consistency and speed of the display providing the correct score.

The systems and methods described herein can reduce the occurrences of constant data transmission that update the score of each respective gameboard by transmitting updates in response to the change of an event (e.g., new object detected on the gameboard). By updating the score during the change of events, the systems and methods described herein can reduce wasted energy, which can improve the efficacy of the data transmissions.

At least one aspect of the technical solution is directed to a system. The system can include one or more processors coupled with memory. The one or more processors can receive an indication representative of interactions of a plurality of objects with one or more portions of a first display device or a second display device. The one or more portions can include i) a first portion corresponding to a face of the respective display device and ii) a second portion corresponding to a hole within the respective display device. The plurality of objects can include a first object and a second object. The one or more processors can transmit, to the second board, a wireless communication signal that includes the indication, in response to receiving the indication of interactions with the one or more portions of the first display device. The one or more processors can cause a display, on the first display device and the second display device, of a score indicating the interactions of the first object and the interactions of the second object on the one or more portions of the first display device.

At least one aspect of the technical solution is directed to a system. The system can include one or more processors coupled with memory. The one or more processors can receive an indication representative of interactions of a plurality of objects with one or more portions of a first cornhole gameboard or a second cornhole gameboard. The one or more portions can include i) a first portion corresponding to a face of the respective cornhole gameboard and ii) a second portion corresponding to a hole within the respective cornhole gameboard. The plurality of objects can include a first object and a second object. The one or more processors can transmit, to the second board, a wireless communication signal that includes the indication, in response to receiving the indication of interactions with the one or more portions of the first cornhole gameboard. The one or more processors can cause a display, on the first cornhole gameboard and the second cornhole gameboard, of a score indicating the interactions of the first object and the interactions of the second object on the one or more portions of the first cornhole gameboard.

The one or more processors can cause the second cornhole gameboard to generate an output of the score for display based on the wireless communication signal. The one or more processors can execute a paring operation to synchronize first a cornhole gameboard and the second cornhole gameboard by using communication circuitry. A display can be located on the face of first cornhole gameboard and located above the hole. The first cornhole gameboard and the second cornhole gameboard can include a user input device on a rear side of the first portion. The first cornhole gameboard can be identical to the second cornhole gameboard. The one or more processors can update the score on the display of the first cornhole gameboard in response to transmitting the wireless communication signal to the second cornhole gameboard.

The first cornhole gameboard and the second cornhole gameboard maintain a history of the score. The one or more processors can encode within the wireless communication signal, a plurality of symbols indicating the interactions with the of the first object and the second object. The one or more processors can cause the second cornhole gameboard to decode the wireless communication signal to extract the plurality of symbols to display the interactions with the first object and the second object.

At least one aspect of the technical solution is directed to a method. The method can include receiving, by one or more processors, an indication representative of interactions of a plurality of objects with one or more portions of a first cornhole gameboard or a second cornhole gameboard. The one or more portions can include i) a first portion corresponding to a face of the respective cornhole gameboard and ii) a second portion corresponding to a hole within the respective cornhole gameboard. The plurality of objects can include a first object and a second object. The method can include causing transmission, by the one or more processors, to the second board, a wireless communication signal, in response to receiving the indication of interactions with the one or more portions of the first cornhole gameboard. The method can include causing display, by the one or more processors, on the first cornhole gameboard and the second cornhole gameboard, of a score indicating the interactions of the first object and the interactions of the second object on the one or more portions of the first cornhole gameboard.

At least one aspect of the technical solution is directed to a cornhole gameboard system. The cornhole gameboard system can include a user input device, a processing circuit, a display and a first cornhole gameboard. The processing circuit can receive an indication representative of interactions of a plurality of objects with one or more portions of the first cornhole gameboard or a second cornhole gameboard. The one or more portions can include i) a first portion corresponding to a face of the respective cornhole gameboard and ii) a second portion corresponding to a hole within the respective cornhole gameboard. The plurality of objects can include a first object and a second object. The processing circuit can cause transmission, to the second board, of a wireless communication signal including the indication, in response to receiving the indication of interactions with the one or more portions of the first cornhole gameboard. The one or more processors can cause display, on the first cornhole gameboard and the second cornhole gameboard, of a score indicating the interactions of the first object and the interactions of the second object on the one or more portions of the first cornhole gameboard.

### BRIEF DESCRIPTION OF DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram depicting a system for automatic scoreboard synchronization, according to some implementations.

FIG. 2 is an example of a gameboard for automatic scoreboard synchronization. according to some implementations.

FIG. 3 is an example scores shown on a display of the gameboard, according to some implementations.

FIG. 4 is an example wireless communication signal that includes a preamble to display the score, according to some implementations.

FIG. 5 is a flowchart of a method for automatic scoreboard synchronization.

The details of various implementations of the methods and systems are set forth in the accompanying drawings and the description below.

### DETAILED DESCRIPTION

The following disclosure provides many different implementations, or examples, for implementing different features of the provided subject matter. Specific examples of components and arrangements are described below to simplify the present disclosure. These are merely examples and are not intended to be limiting. For example, a first feature in communication with or communicatively coupled to a second feature in the description that follows can include implementations in which the first feature is in direct communication with or directly coupled to the second feature and can also include implementations in which additional features can intervene between the first and second features, such that the first feature is in indirect communication with or indirectly coupled to the second feature. In addition, the present disclosure can repeat reference numerals and/or letters in the various examples. This repetition is for the purpose of simplicity and clarity and does not in itself dictate a relationship between the various implementations and/or configurations discussed.

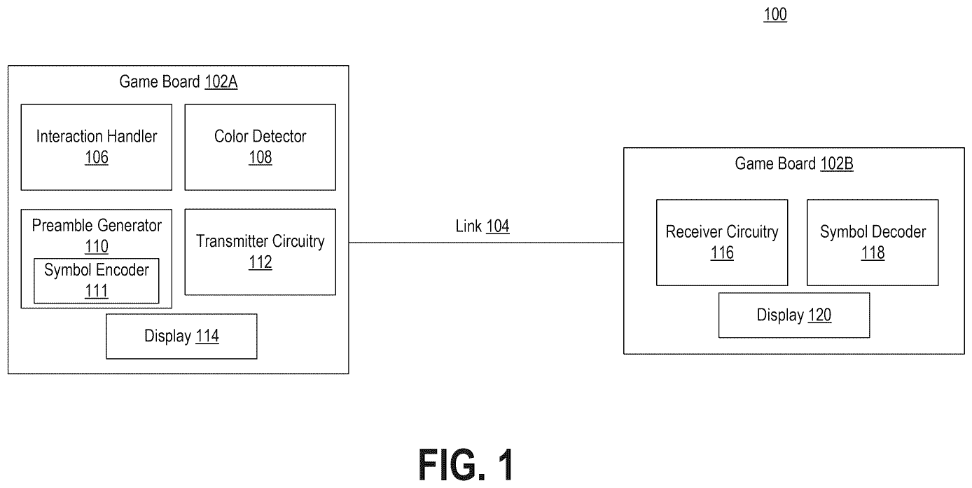

FIG. 1 is a block diagram of a system 100 for automatic scoreboard synchronization is depicted. The system 100 can include a communication environment or a game environment, such as a cornhole gameboard 102A and a cornhole gameboard 102B (sometimes referred to as gameboards 102). The gameboards 102 can be configured to communicate with each other via one or more communication links 104. The gameboards 102 can be a display device that include one or more electrical components to display and modify a displayed score. The gameboard 102A can include one or more components to facilitate data transmission across a network (e.g., links 104, WIFI, Bluetooth, etc.), such as at least one interaction handler 106, at least one color detector 108, at least one preamble generator 110, transmitter circuity 112, and at least one display 114.

Referring briefly to FIG. 1, the interaction handler 106 can receive an indication that is representative of an interaction with the gameboards 102. The color detector 108 can identify a color of an object on the gameboard 102. The preamble generator 110 can generate at least one preamble with one or more Network Processing Protocol (NPP) symbols. The transmitter circuity 112 can transmit data to the gameboard 102B from the gameboard 102A. The display 114 can present a score on the gameboard 102A. Across the link 104, the gameboard 102B can include at least one of receiver circuity 116 a symbol decoder 118, and a display 120. The gameboards 102 can include one or more processors coupled with memory which can include, store and provide access to instructions, commands or data configuring the one or more processors to implement various functionalities of these devices described herein.

Referring to FIG. 1 in further detail, the gameboard 102A can include any combination of hardware and software for providing signals that can be transmitted across one or more links 104. The gameboard 102A can include any computing device, such as an access point of a wireless local area network (WLAN), such as a Wireless-Fidelity (Wi-Fi) router or access point, a smartphone, a computer or any other computing device configured for wireless communication and capable of transmitting wireless signals. The gameboard 102A can also be configured to function as a gameboard 102B and can include any functionality of the gameboard 102B.

The gameboard 102B can include any combination of hardware and software for receiving and processing transmissions from the gameboard 102A via the links 104. The gameboard 102B can include one or more hardware components to receive data packets across a network, such as receiver circuity 116 and at least one symbol decoder 118. The gameboard 102B can include a WLAN access point device, a computer, a smartphone or any other computing device capable of wireless communication. The gameboard 102B can be configured for any wireless communication, including WLAN communication, Bluetooth communication, cellular network communication, or any other radio frequency communication. The gameboard 102B can be configured to function as the gameboard 102A and can include any functionality of the gameboard 102A.

The gameboards 102 can be made of a wooden material capable to hold one or more objects. The wooden material can include and circuity embedded within the gameboards 102. The circuitry can electrically couple each of the components within the gameboard 102A (e.g., interaction handler 106, preamble generator 110, display 114). The gameboards 102 can include one or more portions that correspond to the location of the objects. The one or more portions can correspond to a face and a hole of the gameboard 102A as described herein. The gameboard 102A can be identical to the gameboard 102B.

The links 104 for communication between the gameboard 102A and the gameboard 102B can include any connection or functionality for providing connectivity between devices. The links 104 can include any combination of wired and wireless connections or communications using any networking techniques or any transmission of data between the gameboard 102A and the gameboard 102B, by allowing communication and interaction between the entities. For instance, links 104 can be established occur through Universal Serial Bus (USB) cables, Ethernet cables, High Definition Multi-Media Interface HDMI) cables, wireless local area network (WLAN) functionalities, such as Wi-Fi access points, Bluetooth devices, cellular networks, among others.

The interaction handler 106 can include any combination of hardware and software for detecting and receiving an interaction with the gameboards 102. For example, the interaction handler 106 can include one or more input devices such as one or more buttons, switches, toggles, dials, sensors, or various combinations thereof, for example without limitation. The interaction handler 106 can detect interactions with the one or more input devices. By interacting with the one or more input devices, the interaction handler 106 can adjust and change the score of both the gameboards 102 in synchronization. The interaction handler 106 can include the display 114, or can be separate from the display 114.

The preamble generator 110 can store a representation of the score, and initialize and/or update the score based at least on the user input detected by the interaction handler 106. The preamble generator 110 can include any combination of hardware and software for generating and utilizing preambles or signals. The preamble generator 110 can generate a wireless communication signal to transmit to the gameboard 102B. The wireless communication signal can include the score based on the user input to the interaction handler 106. In some instances, the preamble generator 110 can generate the wireless communication signal to include a preamble. The preamble can include any portion of a communication packet or a frame that includes data (e.g., synchronization sequences, symbols, the score) that can be used by the gameboard 102B to synchronize the communication. The preamble generator 110 can establish synchronization between the gameboard 102A and the gameboard 102B. The preamble generator 110 can be integrated into Network Interface Cards (NICs), a baseband processor within the gameboard 102A, a FPGA, among others. The preamble generator 110 can generate a sequence of symbols or bit patterns at the beginning of the wireless communication signal.

In further detail, the transmitter circuity 112 of the gameboard 102A can be a transmitter communication system and the receiver circuity 116 of the gameboard 102B can include a receiver communication system (sometimes referred to as “communication systems” herein). These components can operate together to exchange data through a wired or wireless medium (e.g., links 104). The gameboard 102A, as well as the gameboard 102B, can include application specific integrated circuit (ASIC), field programmable gate array (FPGA), or any combination of these, in one or more implementations. The gameboards can include any network communication devices such as wireless local area network (WLAN) access points (e.g., Wi-Fi router), a smartphone device, a personal computer, a smartwatch or any other device configured for wireless or network communication. For example, communication systems include transceiver circuitry to allow bi-directional communication between the communication systems or with other communication systems

The transmitter circuity 112 of the gameboard 102A can include or correspond to a circuitry that receives the data from the interaction handler 106 and transmits a wireless communication signal according to the data (e.g., updated score). The transmitter circuity 112 can transmit, to the gameboard 102B, a wireless communication signal that can include a preamble formed by symbols to cause the receiver circuitry 116 to identify the score of the gameboard 102A. In some instances, the interaction handler 106 can trigger the transmitter circuitry 112 to update the score located on the display 114. In this manner, the receiver circuitry 116 of the gameboard 102B can automatically detect a change on this score on the display 114 and update the score on the display 120 accordingly. The receiver circuity 116 of the gameboard 102B can be a circuitry that receives the wireless communication signal from the gameboard 102A, across the link 104, and obtains the score from the received wireless communication signal. The transmitter circuity 112 114 can be the same as the receiver circuity 116. In this manner, the gameboard 102B can synchronize the score with the gameboard 102A.

The display 114 can include any combination of hardware and software for receiving interactions and presenting scores. The display 114 can be, for example, a light emitting display (LED), a liquid crystal display (LCD), a built in board display, among other. The display 114 can be electrically connected to the various components of the gameboard 102 to receive and display the score. The display 114 can be then same as display 120 on the gameboard 102B.

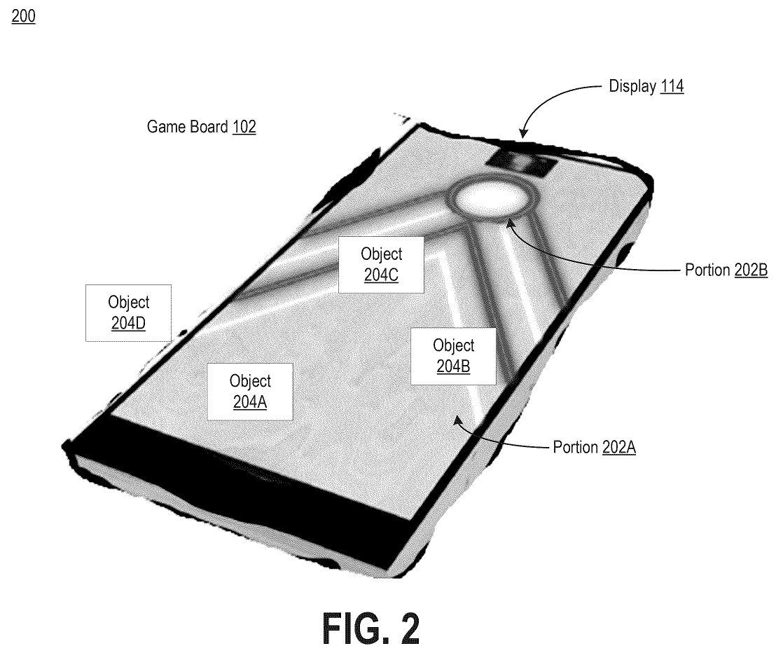

FIG. 2 depicts an example 200 of the gameboard 102 for automatic scoreboard synchronization. The gameboard 102 can include the display 114, a plurality of objects 204A-D (generally referred to as objects 204), a first portion 202A and a second portion 202B (sometimes referred to as portions 202). Various components of the system 100 can be coupled with or integrated into the gameboard 102, including by any one or more adhesives, fasteners, shock absorbers, or various combinations thereof.

The portions 202 can correspond to different sections of the gameboard 102. For example, the first portion 202A can correspond to a face or a surface of the gameboard 102. The face of the gameboard 102 can be a smooth, flat, or lightly fractioned surface to allow objects 204 to slide upon impact. In some cases, the objects 204 can slide off the gameboard 102. In some instances, the objects 204 can slide and remain on the gameboard 102. The portions 202 can include the second portion 202B that corresponds to a hole within the gameboard 102. The second portion 202B can be a circular, elliptic, oval, or section within the gameboard 102 to allow the object 204 to pass through. Each portion 202 can correspond to a score based on where the object 204 lands. For example, when the object 204 lands on the first portion 202A, the object 204 is worth one point. In another example, when the objects 204 lands in the second portion 202B, the object 204 is worth three points.

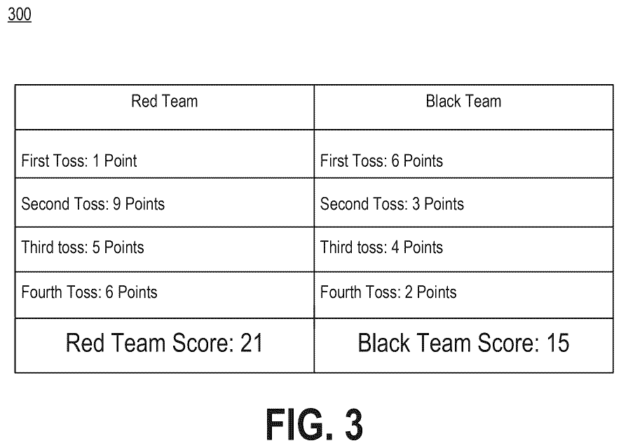

FIG. 3 depicts an example of the score 300 presented on the display 114 and the display 120. The score 300 can correspond to a number of interactions of the objects with the gameboards 102. For example, each time that at least one object lands and stays on the first portion 202A of the gameboard 102, the score 300 for the respective team can be incremented by one point and displayed on both the gameboards 102. In another example, each time that at least one object 204 lands within the second portion 202B of the gameboard 102, the score 300 for the respective team can be incremented by three points. The score 300 can be automatically set or manually determined by using the interaction handler 106. For example, the interaction handler 106 can receive an indication to increase the score by five points for the red team, therefore the interaction handler 106 can extract the previous score for the red team and increase the previous score by five points.

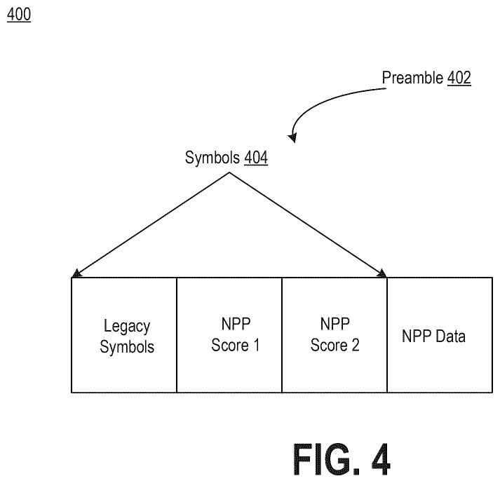

FIG. 4 is an example wireless communication signal 400 that includes a preamble 402. The preamble generator 110 can generate the preamble 402 for transmission to the second gameboard 102B. The preamble 402 can include a plurality of symbols 404. The preamble generator 110 can include a symbol encoder 111. The symbol encoder 111 can generate and encode a plurality of symbols based on the score of each gameboard. Each symbol 404 can correspond to legacy symbols, the score of the first team and the score of the second team. The legacy symbols can include a history based on interactions between the gameboards 102 and instructions to configure the respective gameboard 102 to accept the preamble 402. In this manner, the gameboards 102 can be synchronized to display the same score 300 and update the score 300 as a new object 204 is detected.

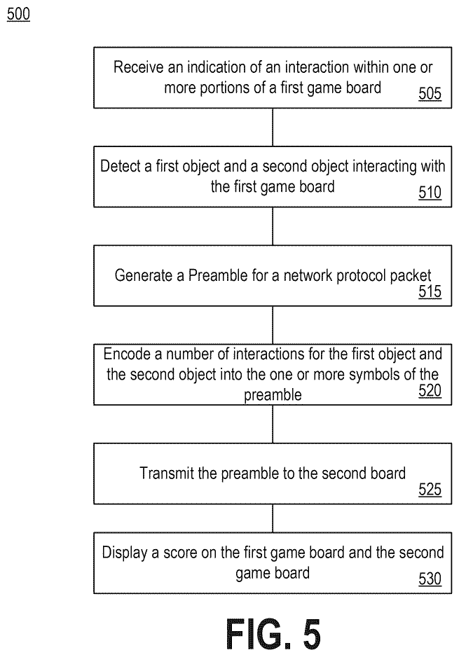

FIG. 5 is a flowchart of a method 500 for marker sequences for automatic scoreboard synchronization. For example, example method 500 can be implemented using example system 100 or any features of techniques as discussed in connection with FIGS. 2-4. For instance, the method 500 can be implemented using example system 100 deployed in connection with a WLAN access point device.

At step 505, the interaction handler 106 can receive an indication of an interaction with the portions 202 of the gameboard 102A. The interaction handler 106 can be a user input device that is located on a rear side of the gameboards 102 opposite of the display 114. The indication of an interaction can be, for example, tapping, swiping, clicking, hovering, voice commands, button presses among other interactions. For example, after a first round of playing cornhole, a player can update the score by pressing a button on at least one gameboard 102 causing the interaction handler 106 to increase the score by a certain number of points. Based on the interactions, the interaction handler 106 can increase the score according to the number of points.

The interaction handler 106 can receive an interaction with the display 114 that indicates one or more parameters for the game associated with the gameboards 102. The one or more parameters can include a time period to update the score, the color of each team, the number of rounds in the game, the number of objects 204 per team, among other parameters. Upon reception of the one or more parameters, the gameboard 102A can transmit a signal to the gameboard 102B via the transmitter circuity 112, to configure the gameboard 102B. In this manner, the gameboards 102 can synchronize prior to detecting objects 204.

In some instances, the indication of an interaction can correspond to a notification that an object 204 is approaching the gameboard 102 or that the object 204 has landed on one or more portions of the gameboard 102. In some instances, the interaction can be a movement of a player on a team tossing the object 204. Upon detection of the movement, the interaction handler 106 can trigger the color detector 108 to determine the color of the object 204. The color detector 108 can determine the color of the object 204 by being coupled with at least one of a color camera, a color sensor, or an infrared sensor. For example, the color detector 108 can trigger a camera to capture a plurality of images of the object 204. The color detector 108 can execute an algorithm to isolate the object 204 from the rest of the image, extract a plurality of pixel values corresponding to the object 204, and perform color matching. By determining the color of the object 204 prior to the object hitting the gameboard 102, the interaction handler 106 can associate the interaction with the correct team.

In some instances, the interaction handler 106 and the color detector 108 can detect objects interacting with the gameboard 102. The interaction handler 106 and the color detector 108 can detect objects interacting with the gameboard 102, in response to receiving the indication within the portions 202 of the gameboard 102. The interaction handler 106 can detect multiple objects 204 interacting with the first portion 202A of the gameboard 102 and multiple objects 204 interacting with the second portion 202B of the first gameboard 102A. Upon detecting the interactions, the interaction handler 106 can store each interaction based on the color of the object 204. By storing the color of each object 204, each gameboard can update the respective score and transmit the updated score to the subsequent gameboard.

Upon receiving the indication of an interaction, the interaction handler 106 can execute a pairing operation to synchronize the score 300 displayed on the gameboard 102A and the score 300 displayed on the gameboard 102B. The pairing operation can trigger the subsequent steps as described herein. The pairing operation can cause the transmitter circuity 112 to transmit a signal to the receiver circuitry 116 to notify the gameboards 102 that synchronization is occurring.

The preamble generator 110 can generate a wireless communication signal to the gameboard 102B, in response to receiving the indication of the interaction. The wireless communication signal can include a preamble for a network protocol packet (NPP). When generating the preamble 402, the preamble generator 110 can extract data previously transmitted between the gameboards 102 to maintain a history of points per round as shown in FIG. 3. The history can include scores for each round during the game of cornhole. B maintaining the history, the preamble generator 110 can generate an output that includes the score for each round of cornhole. Concurrently, the preamble generator 110 can receive the interactions based on the color of the objects 204 from the interaction handler 106. Once received, the preamble generator 110 can encode the one or more symbols 404 into the preamble 402.

In some instances, the preamble generator 110 can encode the interactions for the objects into one or more symbols of the preamble. The interactions can be encoded according to the color of the respective objects 204. For example, the interactions with the black objects 204 (e.g., black team) can be seven (i.e., seven points) and the interactions with the red objects 204 (e.g., red team) can be four (i.e., four points). From here, the preamble generator 110 can encode the number of interactions as two different symbols 404 of the preamble 402 after the legacy symbols 404. In this manner, the gameboards 102 can synchronize the score at every instance of the game or responsive to each interaction with at least one gameboard.

At step 510, the transmitter circuity 112 can transmit the wireless communication signal to the gameboard 102B across the link 104. The wireless communication signal can include the preamble 402 indicating the total score and the score for previous round of the game. The wireless communication signal can be a network protocol packet to cause receiver circuity 116 of the gameboard 102B to trigger the symbol decoder 118 to decode the one or more symbols 404 of the preamble 402. Once decoded, the gameboard 102B can extract the scores from the symbol to generate an output for display.

At step 515, the display 114 can display a score on the gameboards 102 indicating the interactions of the objects 204. The display 114 can be located on the first portion 202A of the gameboard 102A and above the second portion 202B. The location of the display 120 on gameboard 102B can be the same as the location of the display 114 on the gameboard 102A. The display 114 can be synchronized to the display 120, such that when changes occur in the display 114, the systems and methods described herein can adjust the display 120 in real time (or near real time). Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary implementations, and that such variations are intended to be encompassed by the present disclosure.

What is claimed is:

1. A system, comprising:
one or more processors coupled with memory to:
receive an indication representative of interactions of a plurality of objects with one or more portions of a first cornhole gameboard or a second cornhole gameboard, the one or more portions including i) a first portion corresponding to a face of a respective cornhole gameboard and ii) a second portion corresponding to a hole within the respective cornhole gameboard, the plurality of objects including a first object and a second object;
in response to receiving the indication of interactions with the one or more portions of the first cornhole gameboard, transmit, to the second cornhole gameboard, a wireless communication signal corresponding to the indication; and
cause, on the first cornhole gameboard and the second cornhole gameboard, a display of a score indicating the interactions of the first object and the interactions of the second object on the one or more portions of the first cornhole gameboard.

2. The system of claim 1, wherein the one or more processors are configured to execute a pairing operation to establish a communication link between communication circuitry of the first cornhole gameboard and of the second cornhole gameboard.

3. The system of claim 1, wherein the one or more processors are configured to cause a display of the second cornhole gameboard to present an output, based on the indication, representing the score.

4. The system of claim 1, wherein a display is located on the face of the first cornhole gameboard and located above the hole.

5. The system of claim 1, wherein the first cornhole gameboard and the second cornhole gameboard include a user input device on a rear side of the first portion.

6. The system of claim 1, wherein the first cornhole gameboard is identical to the second cornhole gameboard.

7. The system of claim 1, wherein the one or more processors are configured to update the score on a display of the first cornhole gameboard in response to a transmission of the wireless communication signal to the second cornhole gameboard.

8. The system of claim 1, wherein the one or more processors are configured to maintain a history of the score and generate an output based on the history and the indication.

9. The system of claim 1, wherein the one or more processors are configured to:
encode, within the wireless communication signal, a plurality of symbols indicating the interactions with the first object and the second object; and
cause a processor of the second cornhole gameboard to decode the wireless communication signal to extract the plurality of symbols to display the interactions with the first object and the second object.

10. A method, comprising:
receiving, by one or more processors, an indication representative of interactions of a plurality of objects with one or more portions of a first cornhole gameboard or a second cornhole gameboard, the one or more portions including i) a first portion corresponding to a face of the respective cornhole gameboard and ii) a second portion corresponding to a hole within the respective cornhole gameboard, the plurality of objects including a first object and a second object;
in response to receiving the indication of interactions with the one or more portions of the first cornhole gameboard, transmitting, by the one or more processors, to the second cornhole gameboard, a wireless communication signal; and
causing, by the one or more processors, on the first cornhole gameboard and the second cornhole gameboard, a display of a score indicating the interactions of the first object and the interactions of the second object on the one or more portions of the first cornhole gameboard.

11. The method of claim 10, further comprises causing, by the one or more processors, the second cornhole gameboard to generate an output of the score for display based on the wireless communication signal.

12. The method of claim 10, further comprises executing, by the one or more processors, a pairing operation to synchronize first a cornhole gameboard and the second cornhole gameboard by using communication circuitry.

13. The method of claim 10, wherein a display is located on the face of first cornhole gameboard and located above the hole.

14. The method of claim 10, further comprising receiving, by the one or more processors, the indication via a user input.

15. The method of claim 10, wherein the first cornhole gameboard is identical to the second cornhole gameboard.

16. The method of claim 10, further comprising updating, by the one or more processors, a score on a display of the first cornhole gameboard in response to transmitting the wireless communication signal to the second cornhole gameboard.

17. The method of claim 10, further comprising maintaining, by the one or more processors, a history of the score.

18. The method of claim 10, further comprising:
encoding, by the one or more processors within the wireless communication signal, a plurality of symbols indicating the interactions with the first object and the second object; and
causing, by the one or more processors, the second cornhole gameboard to decode the wireless communication signal to extract the plurality of symbols to display the interactions with the first object and the second object.

19. A cornhole gameboard system, comprising:
a user input device;
a display; and
a first cornhole gameboard comprising a processing circuit comprising one or more processors configured to:
receive an indication representative of interactions of a plurality of objects with one or more portions of the first cornhole gameboard or a second cornhole gameboard, the one or more portions including i) a first portion corresponding to a face of the respective cornhole gameboard and ii) a second portion corresponding to a hole within the respective cornhole gameboard, the plurality of objects including a first object and a second object;
in response to receiving the indication of interactions with the one or more portions of the first cornhole gameboard, transmit, to the second cornhole gameboard, a wireless communication signal comprising the indication; and
display, on the first cornhole gameboard, a score indicating the interactions of the first object and the interactions of the second object on the one or more portions of the first cornhole gameboard.

20. The cornhole gameboard system of claim 19, wherein the one or more processors are configured to cause the second cornhole gameboard to generate an output of the score for display based on the wireless communication signal.
